(19) United States
(12) Patent Application Publication
(10) Pub. No.: US 2025/0094769 A1
(43) Pub. Date: Mar. 20, 2025

(54) HYBRID AGENT FOR PARAMETER OPTIMIZATION USING PREDICTION AND REINFORCEMENT LEARNING

(71) Applicant: Telefonaktiebolaget LM Ericsson (publ), Stockholm (SE)

(72) Inventors: Jaeseong JEONG, Solna (SE); Wenfeng HU, Täby (SE); Konstantinos VANDIKAS, Solna (SE); Alexandros NIKOU, Danderyd (SE); Maxim TESLENKO, Sollentuna (SE)

(21) Appl. No.: 18/843,217

(22) PCT Filed: Feb. 16, 2023
(86) PCT No.: PCT/EP2023/053906

§ 371 Date: Aug. 30, 2024

(30) Foreign Application Priority Data
Mar. 15, 2022 (GR) 20220100233

(51) Int. Cl. G06N 3/0442; G06N 3/092

(52) U.S. Cl. CPC G06N 3/0442; G06N 3/092

(57) ABSTRACT

A computer-implemented method for reinforcement learning includes obtaining a first observation oₜ₋₁ of an environment at an end of a first time step t-1, generating a prediction o′ₜ of a second observation oₜ of the environment at the end of a second time step t based on at least the first observation, obtaining a predicted state s′ₜ of the environment at the second time step t from the predicted second observation o′ₜ, selecting an action aₜ to execute on the environment during the second time step based on the predicted state s′ₜ and a policy π, and executing the action aₜ on the environment.

### TECHNICAL FIELD

The present disclosure relates to systems and methods for reinforcement learning. In particular, the present disclosure relates to systems and methods for managing computer-controlled infrastructure systems, such as telecommunications systems using reinforcement learning.

### BACKGROUND

Reinforcement learning (RL) is a field of machine learning (ML) that is used for systems that can autonomously control and/or interact with an environment. An RL agent observes the state of the environment and takes actions on the environment based on a policy. The state of the environment is observed at regular intervals, called time steps. An observation is a vector of features that characterize the environment. When an action is taken on the environment by the RL agent, the state of the environment changes in response to the action and a reward is generated. The policy is then updated based on the reward and the new state of the environment. The goal of an RL agent is to learn a policy that maximizes an expected average reward. Accordingly, RL is viewed as a promising approach for control systems that make sequential decisions in complex, uncertain environments.

One potential use for reinforcement learning is base station parameter optimization in a wireless communication network. The goal of base station parameter optimization is to select and implement a set of operating parameters for the base station based on observed conditions in the network that achieves a desired operating condition or result of interest.

A base station in a wireless communication system may operate multiple cells. Each cell has many parameters that are tunable to optimize network performance, such as coverage and capacity. Some examples of these type of parameters are antenna tilt (electrical and digital) and nominal uplink power per resource block on the physical uplink shared channel (PO Nominal PUSCH). An RL agent can change either of these quantities based on a policy in response to an observation of the wireless communication system.

Remote Electrical Tilt (RET) and digital tilt, which define the antenna tilt of the cell, can be changed remotely by a control system. By modifying the antenna tilt, the Downlink (DL) Signal to Interference plus Noise Ratio (SINR) can be improved in the cell. However, the SINR of the surrounding cells can be degraded as a result of the chosen antenna tilt.

The PO Nominal PUSCH defines the target power per resource block (RB) which the cell expects in Uplink (UL) communication, from the User Equipment (UE) to the Base Station (BS). By increasing PO Nominal PUSCH, the UL SINR in the cell may increase (due to increased signal power), but at the same time, the UL SINR in the surrounding cells may decrease (due to increased interference), and vice versa.

By using Reinforcement Learning techniques and training an RL agent on realistic simulators it is possible for the RL agent to learn a policy over time that maximizes an expected value of a suitable reward function.

### SUMMARY

As noted above, RL can be an effective tool for controlling a complex environment by taking sequential actions on the environment. A conventional RL operation by an RL agent is illustrated in FIG. 1. As shown therein, at each time step t, an RL agent first observes the environment oₜ, obtains a state st from oₜ, then executes an action according to a policy based on sₜ. It will be appreciated that an “observation” is a signal from the environment which can be used to partially determine a state of the environment. That is, a “state” is a condition of the environment that is expected to be determined by a combination of observations and actions. In reinforcement learning, the RL agent observes a set of signals from the environment and performs an action on the environment, resulting in a state of the environment.

In some types of environments, as illustrated in FIG. 2, the state sₜ is obtained not from the observation at the same time step oₜ but from the observation at the previous time step oₜ₋₁ due to the length of the time step that is used in such cases. That is, due to the non-negligible duration of each time step t (e.g., a day), the observation oₜ cannot be measured at the beginning of the time step t, but rather is measured at the end of the time step t. As the action aₜ needs to be decided at the beginning of the time step t, many previous solutions take the observation at the previous step oₜ₋₁ (measured at the end of time step t-1) as the source of state sₜ and action aₜ. Although such an approach may be possible, it may suffer from certain drawbacks.

For example, in a communication system, the length of each time step t may have one length, e.g., a day, an hour, a minute, etc. However, the key performance indicators (KPIs) of the network may have a different periodicity, such as a weekly pattern. For example, the network may experience low traffic on Sundays and congestion on Mondays. In that case, the conventional RL approach would decide the action for, e.g., Monday based on Sunday's observation. However, Sunday traffic levels may be significantly different than Monday traffic levels, so a sub-optimal action may be chosen.

FIG. 3 illustrates a conventional RL execution flow with a reward calculation. At time step 1, the RL agent constructs a state s₁ using an observation oₜ₋₁ collected at the previous time step 0. The RL agent then selects an action a₁ based on a policy and executes the action on the environment (such as, for example, changing a nominal uplink power level or a remote antenna tilt). After a few hours, the instant reward r₁ is calculated from observation_1, and a next state s₂ is constructed to be used to perform the next action.

One problem is that there could be confounding system conditions, referred to as “confounders” or “confounder states” that arise or exist between the two observations of the environment. Confounders, which are not observed/controlled by the RL agent, may include conditions such as traffic seasonality. A confounder state is a variable component that is substantially independent of actions taken on the environment. In some cases, a confounder state may have a predictable time-series pattern. Since confounders can impact the observation oₜ₋₁, the reward r₁ is not only causally impacted by a₁ but also by confounders, which can lead to inaccurate learning signals and sub-optimal RL policy learning.

If an RL policy uses a sufficiently large and complex model that can encounter all such complex time-series seasonality patterns, this problem can be resolved. However, in practice, collecting the training samples via random action exploration is a significant challenge.

Some other ML techniques have been proposed for similar problems. For example, the use of long short-term memories (LSTMs) in RL has been proposed where an LSTM is used to learn to improve the learning of Q-values as a sequence of historical values. Such an approach is described in M. Hausknecht and P. Stone, “Deep Recurrent Q-Learning for Partially Observable MDPs,” arXiv:1507.06527v4 [cs.LG] 11 Jan. 2017.

Similarly, a prediction-based multi-agent reinforcement learning (MARL) approach has been proposed that combines a time series prediction model and reinforcement learning agent to address the environment's non-stationarity, such as described in Marinescu, Andrei, Ivana Dusparic, and Siobhan Clarke, “Prediction-based multi-agent reinforcement learning in inherently non-stationary environments.” ACM Transactions on Autonomous and Adaptive Systems (TAAS) 12.2 (2017): 1-23. Such an approach detects a non-stationary change in the environment and uses a prediction model to generate a non-stationary observation which is used to train the RL agent. In this way, the trained RL agents can be adaptive to non-stationarity of the environment. However, such an approach may be time-consuming and expensive.

Some embodiments provide a computer-implemented method that obtains a first observation oₜ₋₁ of an environment at an end of a first time step t-1 and generates a prediction o′ₜ of a second observation oₜ of the environment at the end of a second time step t based on at least the first observation. The method obtains a predicted state s′ₜ of the environment at the second time step t from the predicted second observation o′ₜ, selects an action aₜ to execute on the environment during the second time step based on the predicted state s′ₜ and a policy π, and executes the action aₜ on the environment.

The method may further include obtaining the second observation oₜ of the environment following execution of the action aₜ, determining a reward rₜ based on the second observation oₜ, and updating the policy π based on the reward rₜ.

Generating the prediction o′ₜ of the second observation oₜ may be performed by applying a sequence prediction model to a plurality of previous observations of the environment to obtain the prediction o′ₜ of the second observation oₜ.

The method may further include determining an accuracy of the prediction, and adjusting a number of the previous observations used by the sequence prediction model in response to the determined accuracy.

Adjusting the number of the previous observations used by the sequence prediction model in response to the determined accuracy may include increasing the number of the previous observations used by the sequence prediction model in response to determining that the accuracy of the prediction is less than a threshold level of accuracy.

The sequence prediction model may be a multivariate time series forecasting model, such as a long short term memory, LSTM, model.

Generating the prediction o′ₜ of the second observation oₜ may be performed based on observations from previous time steps, and may be performed based on an assumption that a predetermined action a₀ is taken at the second time step. The predetermined action may be no action.

Generating the prediction o′ₜ of the second observation oₜ may be performed based on side channel information about the environment in addition to the observations from previous time steps.

The method may further include determining that an action taken in the first time step was the predetermined action a₀, and, training a prediction model, that is used to generate the prediction o′ₜ of the second observation oₜ, based on an actual observation oₜ₋₁ at time step t-1.

The first observation oₜ₋₁ may include a static state component, an action dependent state component and a confounder state component. The action dependent state component is a variable component that is dependent on actions taken on the environment and the confounder state is a variable component that is substantially independent of actions taken on the environment. The confounder state may have a predictable time-series pattern.

The environment may include a computer-controlled system, and the first and second observations may include observations of a performance indicator of the system.

The action may include a modification of a configurable parameter of the system that impacts performance indicator.

In some embodiments, the environment may be a wireless communication network, and the observation may include one or more key performance indicators, KPIs, of the wireless communication network, such as a reference signal received power, an interference level, an average downlink signal to interference plus noise ratio, SINR, an average uplink SINR, a nominal uplink power, average data rate, throughput and/or an average uplink neighbor SINR.

The action may include a modification of a configurable network parameter of the wireless communication network, such as a downlink transmit power, an uplink transmit power, and/or an antenna tilt.

A control system according to some embodiments includes a processor, a communication interface coupled to the processor, and a memory coupled to the processor. The memory includes computer readable instructions that when executed by the processor cause the system to perform operations including obtaining a first observation oₜ₋₁ of an environment at an end of a first time step t-1, generating a prediction o′ₜ of a second observation oₜ of the environment at the end of a second time step t based on at least the first observation, obtaining a predicted state s′ₜ of the environment at the second time step t from the predicted second observation o′ₜ, selecting an action aₜ to execute on the environment during the second time step based on the predicted state s′ₜ and a policy π, and executing the action aₜ on the environment.

Some embodiments provide a computer program including program code to be executed by processing circuitry of an apparatus, whereby execution of the program code causes the apparatus to perform operations including obtaining a first observation oₜ₋₁ of an environment at an end of a first time step t-1, generating a prediction o′ₜ of a second observation oₜ of the environment at the end of a second time step t based on at least the first observation, obtaining a predicted state s′ₜ of the environment at the second time step t from the predicted second observation o′ₜ, selecting an action aₜ to execute on the environment during the second time step based on the predicted state s′ₜ and a policy π, and executing the action aₜ on the environment.

A computer program product according to some embodiments includes a non-transitory storage medium having stored therein program code to be executed by processing circuitry of an apparatus, whereby execution of the program code causes the apparatus to perform operations including obtaining a first observation oₜ₋₁ of an environment at an end of a first time step t-1, generating a prediction o′ₜ of a second observation oₜ of the environment at the end of a second time step t based on at least the first observation, obtaining a predicted state s′ₜ of the environment at the second time step t from the predicted second observation o′ₜ, selecting an action aₜ to execute on the environment during the second time step based on the predicted state s′ₜ and a policy π, and executing the action aₜ on the environment.

### BRIEF DESCRIPTION OF THE DRAWINGS

FIG. 1 illustrates conventional operations of a reinforcement learning system.

FIG. 2 illustrates conventional operations of a reinforcement learning system used for communication network management.

FIG. 3 illustrates a conventional RL execution flow with a reward calculation.

FIG. 4 illustrates operations of a hybrid reinforcement learning system according to some embodiments.

FIG. 5 illustrates a hybrid RL execution flow with a reward calculation according to some embodiments.

FIG. 6 illustrates elements of a network management system that includes a hybrid RL agent according to some embodiments.

FIG. 7 illustrates operations of a hybrid RL agent according to some embodiments.

FIG. 8A is a block diagram that illustrates elements of a network management system including a hybrid RL agent according to some embodiments.

FIG. 8B illustrates various functional modules that may be stored in the memory of a network management system according to some embodiments.

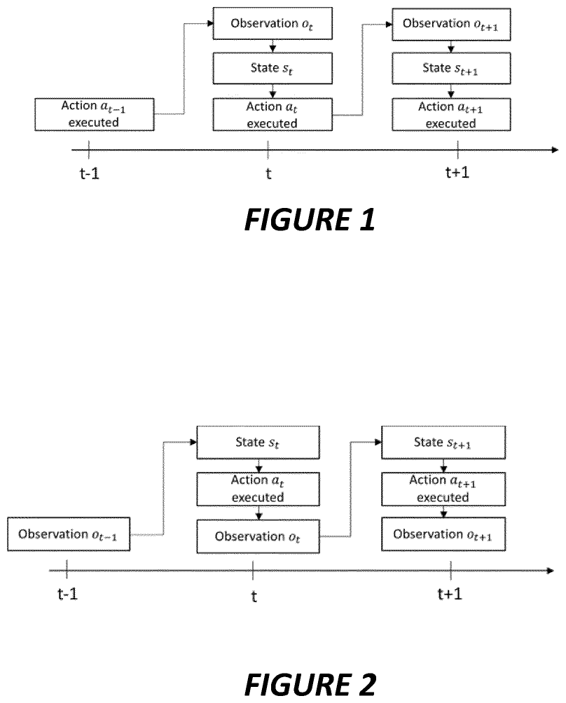

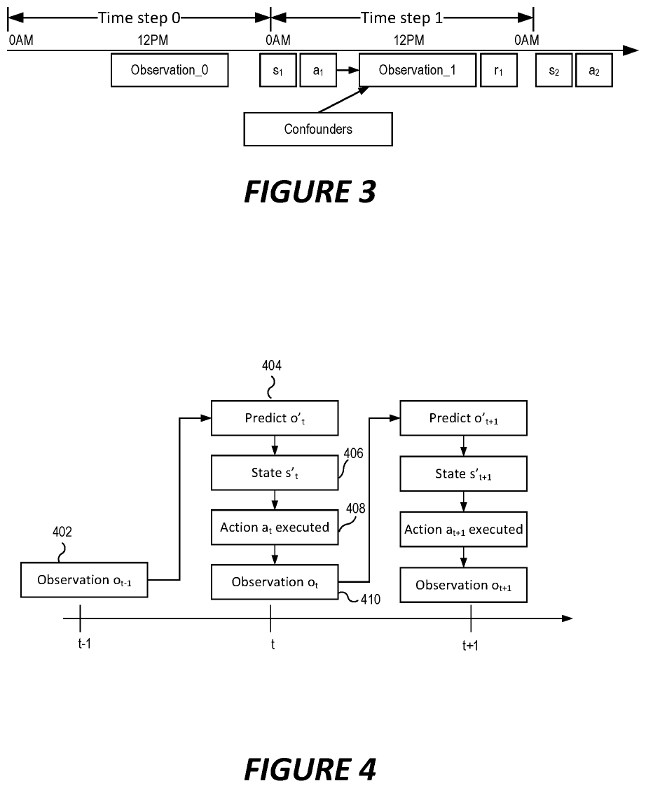

### DETAILED DESCRIPTION OF EMBODIMENTS

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As noted above, a conventional RL approach may have drawbacks when used to control certain types of systems, such as wireless communication systems, since the system may have to use an observation from a previous time step to generate a state and an action aₜ a current time step. To solve this problem, some embodiments use a predictive model to generate a prediction of the current state and use the current state prediction to generate the state and action for the current time step. Such an RL agent may learn how to predict the next observation needed to be used as input for the RL algorithm using a multi-variate approach.

Some embodiments add a prediction model to RL execution flow that predicts a current observation oₜ at the beginning of time step t. For example, referring to FIG. 4, an RL system obtains a first observation oₜ₋₁ of an environment at an end of a first time step t-1 (block 402). The RL system then generates a prediction o′ₜ of a second observation oₜ of the environment at the end of a second time step t based on at least the first observation (block 404). That is, the RL system uses a prediction model to predict the observation oₜ for the case when a predetermined action (e.g., no change) is executed. The prediction model may take as input the observations in previous time steps, and generates the predicted observation o′ₜ as an output by assuming that the predetermined action is executed at time step t.

The RL system then obtains a predicted state s′ₜ of the environment at the second time step t from the predicted second observation o′ₜ (block 406). The RL system then selects an action aₜ to execute on the environment during the second time step based on the predicted state s′ₜ and a policy π, and executes the action aₜ on the environment (block 408). Executing the action may include sending a modified parameter to the environment for implementation. The RL system than obtains an actual observation oₜ for the second time step (block 410), and calculates a reward based on the actual observation oₜ.

Some embodiments may improve the selection and implementation of network parameters by combining RL policy model and prediction models. Some embodiments combine an RL agent and a prediction agent to improve the RL training process. Specifically, some embodiments may use a prediction model to predict an exogeneous time-series pattern in the observation. The RL agent executes a policy based on the predicted observation for the time step in which the action will be executed.

To help facilitate this approach, some embodiments divide the observations into three categories for network parameter optimization, namely, static state, action dependent state and confounder state.

Some embodiments enable an RL agent for network optimization to execute actions based on and learn from the state and reward that are obtained from the exogeneous but, possibly predictable, patterns.

Accordingly, in some embodiments, an RL policy may decide an action based on more relevant information, namely, a predicted observation of the environment at the current time step by assuming a predetermined action is executed. In other words, some embodiments may reduce uncertainty from action-independent time-series patterns (i.e., confounders) in the decision making of RL agent.

Some embodiments may increase the RL training sample-efficiency. In particular, the use of a prediction model as described herein may complement the decision-making task of an RL agent. Thereby, the RL agent policy can use a simpler model that requires less RL training samples (tuples of state, action, reward, next state). The prediction model can be complex, because collecting training data for the prediction model using supervised learning is much easier. Thus, by predicting the observation more accurately with sufficiently complex prediction models, an RL agent can dedicate to learning only action-dependent dynamics by taking a simpler policy that learns from smaller set of RL training samples.

In the case when an observation is not available due to a communication error or other problem, some embodiments can still allow for the RL agent to continue exploring the state space and to propose actions given the likelihood of a certain observation.

Compared to LSTM Q-learning where a LSTM model is used as a deep Q network (DQN), some embodiments use a sequence prediction model (such as LSTM) as a prediction model (supervised learning model) and use a simpler model as a DQN for RL, which may provide sample-efficiency. That is, less exploration may be required for DON training due to its simplicity. An LSTM Q-network takes as input a sequence of states, and thereby, the network structure becomes more complex. Thus, LSTM Q-network requires more exploration of random actions during training. On the other hand, in some embodiments described herein, the prediction model may not require any exploration for training but may only require labeled data for supervised learning. The DON thereby has a more simple model that requires less exploration of random actions.

In contrast to prediction-based MARL where a sequence prediction model is used for adding non-stationarity in the simulation training environment, some embodiments use a sequence prediction model for updating the input of RL policy model (i.e., state) that may improve the decision making of the RL agent.

A hybrid RL agent according to some embodiments is composed of two parts, namely, a prediction model and an RL policy model. The prediction model takes as input the observations in a previous time step (t-1, t-2, . . . ), and generates as output a predicted observation at time step t by assuming a predetermined action (e.g., no change) is executed at the step t. The RL policy model may be a conventional RL policy model that selects an action based on a policy, executes the action and calculates a reward based on the outcome of the action.

As noted above, the state prediction model takes as inputs previous sequence observations or confounder state observations. The prediction model may also take as inputs actions taken on the environment as well as side channel information available to the RL agent. The state prediction model generates as an output a next observation at each time step.

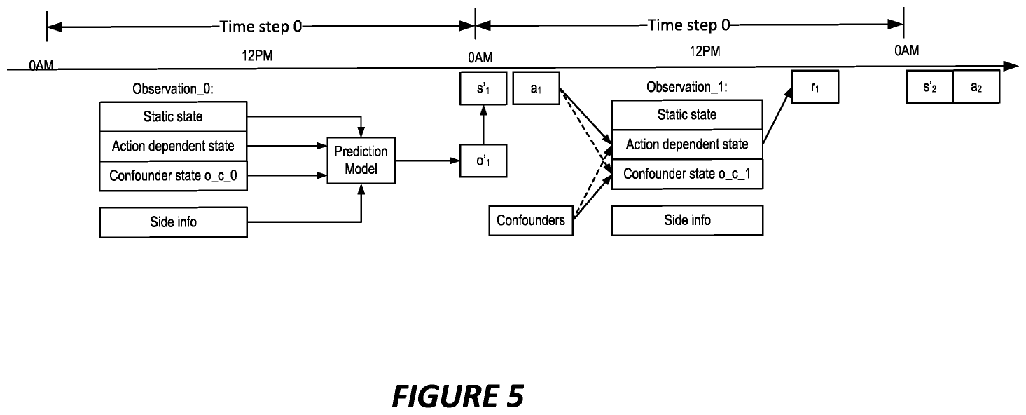

To exemplify the usage of prediction model, an RL execution flow for network optimization that uses a time step equal to one day is illustrated in FIG. 5.

As shown therein, the observation can be categorized into three parts, namely a static state, an action dependent state and a confounder state. The static state is contextual information that is RL action independent. This state does not need to be predicted, but may be useful in forming the RL agent's decision. Essentially, the static state acts like the context in a contextual bandit problem.

The action dependent state is the state that is affected by the action taken by the RL agent on the environment. The action dependent state will impact the RL agent's decision making and will also be impacted by the action executed by RL agent on the environment.

The confounder state is impacted by external factors called confounders, and has no causal relationship, or only a weak causal relationship, with the action executed by the RL agent.

Still referring to FIG. 5, the system makes an observation (observation_0) at or near the end of time step 0. The observation includes the static state, the action dependent state and the confounder state (o_c_0).

At time step 1, the prediction model predicts an observation o′₁ at time step 1 using previous observations as inputs. The prediction is also based on an assumption that a baseline action a₀ will be taken in time step 1. The baseline action a₀ may, for example, be no action (i.e., not to change any parameters of the environment).

As part of the prediction, the prediction model may predict the confounder state (o_c_1)′ using the observed confounder state (o_c_0), as well as historical confounder states and external side channel information, such as social/holiday events, road traffic congestion, etc. The predicted confounder state (o_c_1)′ may be used to construct a predicted observation o′₁ to be used by the RL agent to select an action aₜ time step 1.

The predicted observation o′₁ is then used to generate a predicted state s′₁ for time step 1.

An LSTM model can be used to predict the next confounder state, the next state and the next observation given that there are enough past observations, state information(s), actions (a), and if additional confounding variables to further enhance the accuracy of the LSTM model. The main challenge is to determine how many observations from the past are needed as inputs to accurately predict the next observation. This can be determined by reducing/minimizing the loss between | p(t)−p(t)′| (where p denotes either a prediction that is assigned to the ML model, such as for the next confounder state, for the next state or for the next observation. It is possible to determine the size of historical information iteratively by starting from a fix threshold T which can be a large enough number, such as using 24 hourly samples from the past to predict the next hour. Then, by checking the loss, the size of the historical buffer can be increased or decreased accordingly.

Accordingly, in some embodiments, the RL agent may determine an accuracy of a predicted observation o′ₜ for a time step t by comparing the predicted observation o′ₜ for the time step with the actual observation oₜ for the time step and adjusting a number of the previous observations used by the sequence prediction model in response to the determined accuracy. The number of previous observations used by the prediction model may be adjusted by increasing or decreasing the size of the buffer.

In particular, the RL agent may increase the number of the previous observations used by the sequence prediction model (by increasing the historical buffer size) in response to determining that the accuracy of the prediction is less than a threshold level of accuracy, and vice-versa.

The RL agent then selects an action a₁ to be applied at time step 1 based on the predicted state s′₁ for time step 1 and the policy π. The action a₁ affects the environment, resulting in a new state s₁ that is observed. The RL agent then generates a reward r₁ for time step 1 and updates the policy based on the reward. The process then repeats in the next time step.

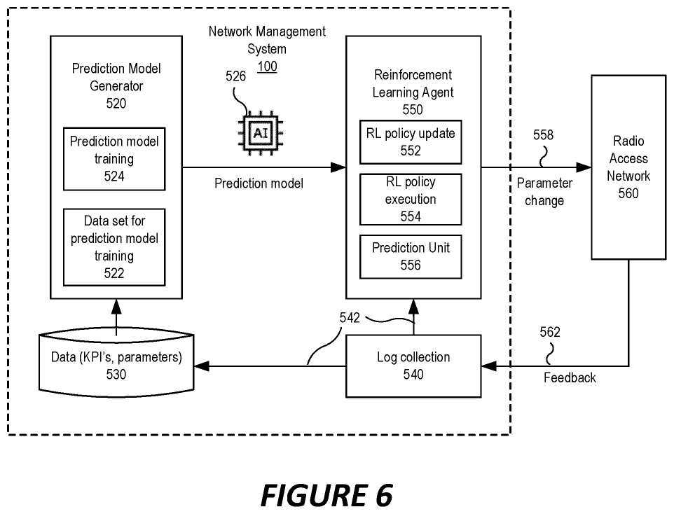

FIG. 6 illustrates elements of a network management system 100 that includes an RL agent 550 according to some embodiments. As shown therein, the network management system 100 includes a prediction model generator 520, the RL agent 550, a data store 530, and a log collection unit 540.

The log collection unit 540 collects log data about an environment 560, which may, for example, be a radio access network (RAN) of a wireless communication system. The log data may include information about the network, such as KPIs and parameters, which may include, for example, signal power levels, interference levels, usage levels, throughput, data rates, etc. The log data 542 is stored in the data store 530 and may also be provided to the RL agent 550. In some embodiments, the RL agent 550 may obtain the log data 542 from the data store 530.

The prediction model generator 520 receives information about the environment from the data store 530, and builds a dataset 526 for prediction model training from the data. The prediction model generator 520 includes a prediction training model 524 that trains a prediction model 526 using the dataset 522 and provides the trained prediction model 526 to the RL agent 550.

The RL agent 550 includes an RL policy update unit 552, an RL policy execution unit 554 and a prediction unit 556. The prediction unit 556 generates a prediction of a current observation o′ₜ using the prediction model 526. The RL agent 550 then generates a predicted state s′ₜ based on the predicted observation o′ₜ. The RL policy execution unit 554 selects an action aₜ based on the predicted state s′ₜ and executes the selected action by transmitting a parameter change command 558 to the environment 560, e.g., the RAN. The action aₜ may cause some changes in the condition of the environment, resulting in changes to network parameters. The updated network parameters are then fed back to the network management system 100 as log data 562.

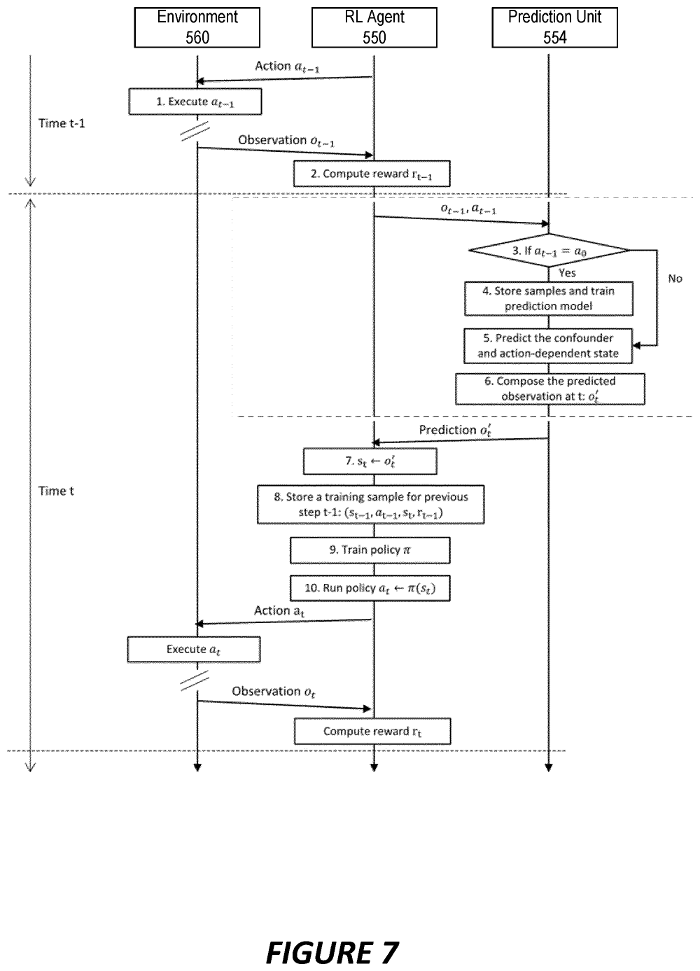

Referring to FIG. 7, operations of an RL agent according to some embodiments are illustrated in more detail. In particular, FIG. 7 illustrates operations of the RL agent 550 as it interacts with the environment 560.

At time step t-1:
Step 1: Execute action aₜ₋₁, e.g., change of the base station or antenna parameters at the beginning of time step t-1.
Step 2: At the end of the time step t-1, measure the observation oₜ₋₁ including KPIs and compute the reward rₜ₋₁ based on the observation.

At the beginning of time step t:
Step 3: Deliver observation oₜ₋₁, aₜ₋₁ to the prediction unit 554, and check to see if the action aₜ₋₁ is equal to the predetermined action a₀.
Step 4: If Yes, store the training sample for prediction (e.g., input: oₜ₋₂, aₜ₋₂,oₜ₋₃, aₜ₋₃, . . . , output: oₜ₋₁), and train a prediction model with the updated samples. That is, if the RL agent determines at Step 3 that the action aₜ₋₁ taken in time step t-1 was the predetermined action a₀, then the RL agent uses the actual observation oₜ₋₁ from time step t-1 as an input to train the prediction model.
Step 5: Predict the confounder state and action-dependent state at time step t by assuming that the action aₜ is equal to the predetermined action a₀.
Step 6: Optionally, combine the predicted confounder state and action-dependent state with the static state to compose the predicted observation o′ₜ. Note that in some embodiments, the prediction model can predict the full observation o′ₜ including the confounder state, the action dependent state and the static state.
Step 7: Obtain state s′ₜ from o′ₜ.
Step 8: Store a tuple of RL training sample for time step t-1.
Step 9: Train the RL policy π.
Step 10: Run the policy to get action aₜ for the given s′ₜ.
Step 11: Execute at in the network at the beginning of the time step t

At the end of time step t:
Step 12: Measure the observation oₜ and compute the reward rₜ

As noted above, some embodiments may be used for optimizing one or more configurable network parameters, such as downlink transmit power, uplink transmit power, antenna tilt, etc. This may help to improve one or more network parameters, such as a wireless terminal's uplink signal to interference plus noise (SINR), uplink throughput, antenna tilt and sector shape, etc.

As noted above, the RL agent may predict a current observation that includes a static state, an action-dependent state and a confounder state. In the context of a communication network, the static state could include (but is not limited to), aspects such as antenna height, E-UTRA Absolute Radio Frequency Channel Number (EARFCN), inter-site distance (ISD), cell location and direction, etc.

In the context of a communication network, the action dependent state may include (but is not limited to) one or more KPIs, such as reference signal received power (RSRP), interference level, average DL SINR, average UL SINR, nominal uplink power, average uplink neighbor SINR, etc.

In the context of a communication network, the confounder state may include (but is not limited to), average number of users, average number of neighbors, traffic volume, handover frequency, etc.

The prediction model described above may be used to predict the state at a next time step, including the confounder state and/or the action-dependent state, by assuming a predetermined action will be taken by the RL agent. Using the predicted confounder state and/or the action-dependent state, the RL agent constructs the input state (consisting of static state, the prediction of confounder and action-dependent state).

Another potential application of some embodiments is for controlling the ventilation units in a data center. The state space in such a setup would typically consist of information about the temperature per quadrant of the data center, the temperature of the cooling water (or other cooling liquid) flowing per quadrant, and/or the desired temperature.

The action space would be setting the temperature of the cooling to achieve the desired temperature.

The confounding state can be a set of observations that is not impacted by the state space, such as the workload, number of tasks in each quadrant, CPU utilization, memory usage, network traffic, failures in the equipment, etc.

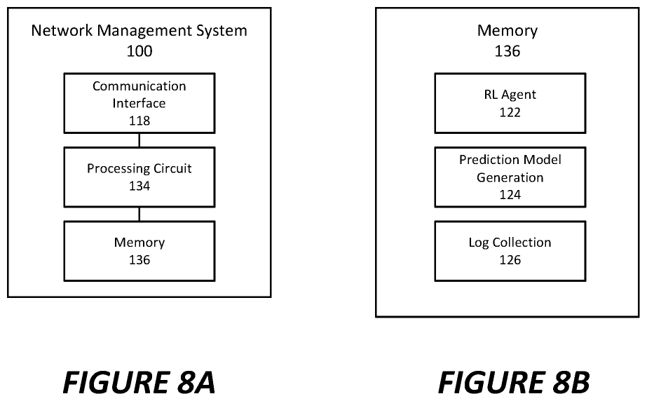

FIG. 8A is a block diagram of a network management system 100 according to some embodiments. The network management system 100 includes a processor circuit 134 a communication interface 118 coupled to the processor circuit 134, and a memory 136 coupled to the processor circuit 134. The processor circuit 134 may be a single processor or may comprise a multi-processor system. In some embodiments, processing may be performed by multiple different systems that share processing power, such as in a distributed or cloud computing system. The memory 136 includes machine-readable computer program instructions that, when executed by the processor circuit, cause the processor circuit to perform some of the operations and/or implement the functions depicted described herein.

As shown, the network management system 100 includes a communication interface 118 (also referred to as a network interface) configured to provide communications with other devices. The network management system 100 also includes a processor circuit 134 (also referred to as a processor) and a memory circuit 136 (also referred to as memory) coupled to the processor circuit 134. According to other embodiments, processor circuit 134 may be defined to include memory so that a separate memory circuit is not required.

As discussed herein, operations of the network management system 100 may be performed by processing circuit 134 and/or communication interface 118. For example, the processing circuit 134 may control the communication interface 118 to transmit communications through the communication interface 118 to one or more other devices and/or to receive communications through network interface from one or more other devices. Moreover, modules may be stored in memory 136, and these modules may provide instructions so that when instructions of a module are executed by processing circuit 134, processing circuit 134 performs respective operations (e.g., operations discussed herein with respect to example embodiments.

FIG. 8B illustrates various functional modules that may be stored in the memory 136 of the network management system 100. The modules may include an RL agent module 122 that performs operations of the RL agent 550 described above, a prediction model generation unit 124 that performs operations of the prediction model generator 520, and a log collection unit 126.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art.

As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method, comprising:
obtaining a first observation oₜ₋₁ of an environment at an end of a first time step t-1;
generating a prediction o′ₜ of a second observation oₜ of the environment at the end of a second time step t based on at least the first observation;
obtaining a predicted state s′ₜ of the environment at the second time step t from the predicted second observation o′ₜ;
selecting an action aₜ to execute on the environment during the second time step based on the predicted state s′ₜ and a policy π; and
executing the action aₜ on the environment.

2. The method of claim 1, further comprising:
obtaining the second observation oₜ of the environment following execution of the action aₜ;
determining a reward rₜ based on the second observation oₜ; and
updating the policy π based on the reward rₜ.

3. The method of claim 1, wherein generating the prediction o′ₜ of the second observation oₜ is performed by applying a sequence prediction model to a plurality of previous observations of the environment to obtain the prediction o′ₜ of the second observation oₜ.

4. The method of claim 3, further comprising:
determining an accuracy of the prediction; and
adjusting a number of the previous observations used by the sequence prediction model in response to the determined accuracy.

5. The method of claim 4, wherein adjusting the number of the previous observations used by the sequence prediction model in response to the determined accuracy comprises increasing the number of the previous observations used by the sequence prediction model in response to determining that the accuracy of the prediction is less than a threshold level of accuracy.

6. The method of claim 3, wherein the sequence prediction model comprises a multivariate time series forecasting model.

7. The method of claim 6, wherein the multivariate time series forecasting model comprises a long short term memory, LSTM, model.

8. The method of claim 5, wherein generating the prediction o′ₜ of the second observation oₜ is performed based on observations from previous time steps, and is performed based on an assumption that a predetermined action a₀ is taken at the second time step.

9. The method of claim 8, wherein the predetermined action comprises no action.

10. The method of claim 8, wherein generating the prediction o′ₜ of the second observation of is performed based on side channel information about the environment in addition to the observations from previous time steps.

11. The method of claim 8, further comprising:
determining that an action taken in the first time step was the predetermined action a₀; and;
training a prediction model, that is used to generate the prediction o′ₜ of the second observation oₜ, based on an actual observation oₜ₋₁ at time step t-1.

12. The method of claim 1, wherein the first observation oₜ₋₁ comprises a static state component, an action dependent state component and a confounder state component, wherein the action dependent state component is a variable component that is dependent on actions taken on the environment and the confounder state is a variable component that is substantially independent of actions taken on the environment.

13. The method of claim 12, wherein the confounder state has a predictable time-series pattern.

14. The method of claim 1, wherein the environment comprises a computer-controlled system, and wherein the first and second observations comprise observations of a performance indicator of the system.

15. The method of claim 14, wherein the action comprises a modification of a configurable parameter of the system, the parameter impacting the performance indicator.

16. The method of claim 14, wherein the environment comprises a wireless communication network, and wherein the observation comprises one or more key performance indicators, KPIs, of the wireless communication network.

17. The method of claim 16, wherein the KPIs comprise a reference signal received power, an interference level, an average downlink signal to interference plus noise ratio, SINR, an average uplink SINR, a nominal uplink power, average data rate, throughput and/or an average uplink neighbor SINR.

18. The method of claim 16, wherein the action comprises a modification of a configurable network parameter of the wireless communication network.

19. The method of claim 18, wherein the configurable network parameter comprises a downlink transmit power, an uplink transmit power, and/or an antenna tilt.

20. A control system, comprising:
a processor;
a communication interface coupled to the processor; and
a memory coupled to the processor, wherein the memory comprises computer readable instructions that when executed by the processor cause the system to perform operations according to claim 1.

21-22. (canceled)
